(19) United States
(12) Patent Application Publication
(10) Pub. No.: US 2005/0071650 A1
(43) Pub. Date: Mar. 31, 2005

(54) Method and apparatus for security engine management in network nodes

(76) Inventors: Su Hyung Jo, Daejeon (KR); Jeong Nyeo Kim, Daejeon (KR); Sung Won Sohn, Daejeon (KR)

Correspondence Address: JACOBSON HOLMAN PLLC, 400 SEVENTH STREET N.W., SUITE 600, WASHINGTON, DC, 20004, US

(21) Appl. No.: 10/743,460

(22) Filed: Dec. 23, 2003

(30) Foreign Application Priority Data
Sep. 29, 2003 (KR) 10-2003-0067442

(51) Int. Cl. H04L 9/32

(52) U.S. Cl. 713/188

(57) ABSTRACT

In a security engine management apparatus in network nodes, a security instruction and library subsystem processes every application program and utility. A policy decision subsystem determines a filtering policy, an intrusion detection policy and an access control policy. An authentication and access control subsystem blocks an unauthorized user to access to a system and allows an authorized user to access thereto according to the access control policy. A policy application subsystem applies the policies. A packet filtering subsystem receives an allowed packet and denies a disallowed packet according to the filtering policy. An intrusion analysis and audit trail subsystem analyzes the intrusion according to the intrusion detection policy. A security management subsystem manages a security engine.

### FIELD OF THE INVENTION

The present invention relates to a method and apparatus for security engine management in network nodes; and, more particularly, to an apparatus and a method for providing functions of a packet filtering, an authentication and an access control management, and an intrusion analysis and an audit trail in a kernel region for the security of network nodes and managing a security engine based on a security policy.

### BACKGROUND OF THE INVENTION

A rapid development and a wide use of the Internet have expanded a network environment. Further, the network environment has become more complex due to a simple and convenient network connection and various services of the Internet.

However, the Internet has been constantly exposed to the danger of various network attacks such as a virus, a hacking, a system intrusion, a system manager authority acquisition, an intrusion cover-up, a denial of service (DoS) attack and the like. Thus, infringement of the Internet is being increased, and the growing damage and influence thereof affect public institutions, social infrastructures and financial institutions.

As a result, a network security technology such as a virus vaccine, a firewall, an integrated security management, an intrusion detection system, and the like are required in order to handle the problems of Internet security.

Accordingly, a router, which is a key component of the Internet, controls a data packet flow in a network and determines an optimal path thereof so as to reach an appropriate destination. An error of the router or an attack against the router can damage an entire network. Moreover, since the router is a device for managing traffic between an internal network and an external network or between different networks, the security thereof is indispensable, thereby requiring a security technology for controlling an access to the router and an illegal network intrusion.

A conventional method of a network security is mainly implemented based on an individual security system having a single function, so that it is difficult to achieve interworking between security systems and construct an information security infrastructure.

### SUMMARY OF THE INVENTION

It is, therefore, an object of the present invention to provide a security engine management apparatus and method in network nodes, which is capable of optimizing an intrusion detection and coping with an illegal network intrusion in real time by providing security functions of a packet filtering, an intrusion analysis and an audit trail, and an authentication and an access control management in a kernel region for the security of network nodes and managing the network nodes based on a security policy, wherein the network nodes include a router, a gateway, and the like that have a security function against a network intrusion.

In accordance with one aspect of the invention, there is provided a security engine management apparatus in network nodes including: a security engine having: a security instruction and library subsystem for processing every application program and utility that are allowed to access to a system source; a policy decision subsystem for determining a filtering policy, an intrusion detection policy and an access control policy that are required for detecting and blocking an intrusion into a network; an authentication and access control subsystem for preventing an unauthorized user from using a system and allowing an authorized user to access to the system in response to an application of the access control policy; a policy application subsystem for analyzing and applying the policies; a packet filtering subsystem for receiving an allowed packet and denying a disallowed packet in response to the application of the filtering policy; and an intrusion analysis and audit trail subsystem for analyzing and coping with the intrusion into the network in response to the application of the intrusion detection policy, and a security management subsystem for managing the security engine.

In accordance with another aspect of the invention, there is provided a method for security engine management in network nodes, including the steps of: (a) receiving a packet from an attack system and examining the packet according to a filtering policy; (b) checking whether the packet is allowed or not, based on the examination result of step (a); (c) passing the packet if the packet is allowed in the step (b) and checking whether or not the allowed packet is an attack intrusion packet according to an intrusion detection policy; and (d) in case the packet is the attack intrusion packet in the step (c), displaying the attack intrusion packet on a security management GUI and informing a mobile terminal by using an SMS and denying the corresponding packet.

In accordance with another aspect of the invention, there is provided a method for providing an integrative security management by using a security policy applied between a router and a security management subsystem, the method comprising the steps of: (a) checking whether or not a user is authorized through a user registration and authentication process; (b) if the user is authorized in step (a), allowing a user to access to the security management subsystem, collecting information on a network composition of hosts, gateways, and routers and storing the collected information in a network database; and (c) displaying security management information on a security management GUI.

### BRIEF DESCRIPTION OF THE DRAWINGS

The above and other objects and features of the present invention will become apparent from the following description of preferred embodiments, given in conjunction with the accompanying drawings, in which:

FIG. 1 shows a schematic diagram of a security engine for blocking an intrusion from an attack system in accordance with a preferred embodiment of the present invention;

FIG. 2 illustrates a detailed diagram of the security engine shown in FIG. 1;

FIG. 3 provides a detailed diagram of a security management subsystem illustrated in FIG. 2;

FIG. 4 depicts a detailed flowchart for describing an operating process of the security engine for detecting and coping in real time with an intrusion from the attack system in accordance with the present invention; and

FIG. 5 presents a detailed flowchart for illustrating a procedure of an integrated security management based on a security policy applied between a router having the security engine and the security management subsystem in accordance with the present invention.

### DETAILED DESCRIPTION OF THE PREFERRED EMBODIMENTS

Hereinafter, preferred embodiments of the present invention will be described in detail with reference to the accompanying drawings.

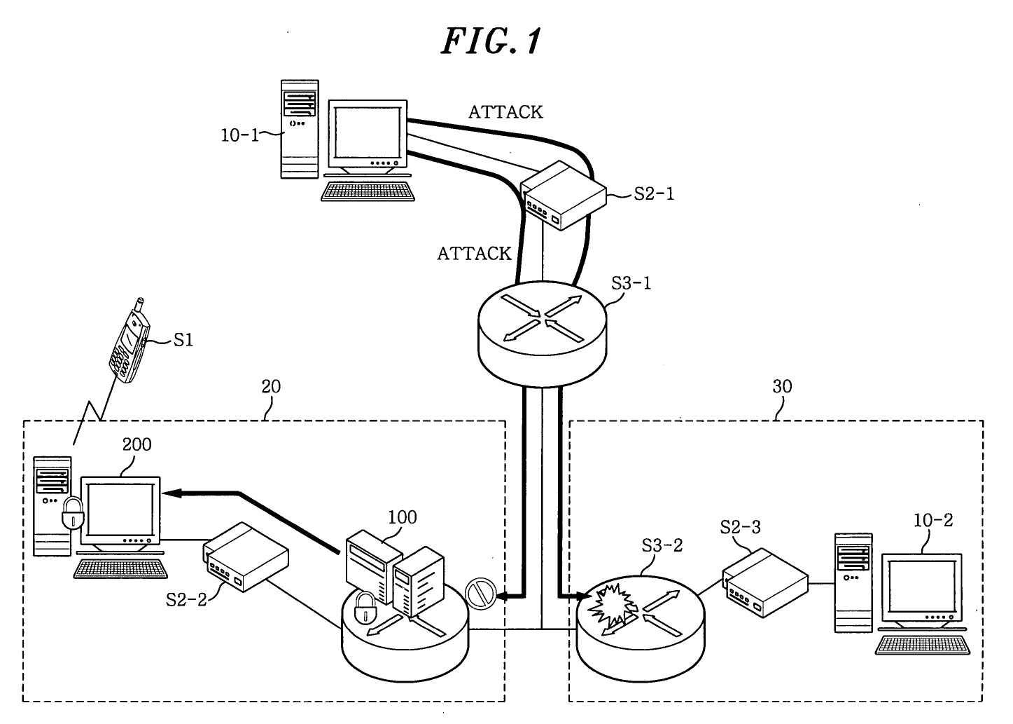

FIG. 1 shows a schematic diagram of a security engine for blocking an intrusion from an attack system in accordance with a preferred embodiment of the present invention. Referring to FIG. 1, there is illustrated a security network 20 including a router 100 having a security engine and a security management subsystem 200 that wirelessly communicates with a mobile terminal S1.

An attack system 10-1 attempts to attack the security network 20 and a general network 30 through a hub S2-1 and a general router S3-1.

Then, the router 100 having a security engine in the security network 20 detects and blocks a network attack by applying a filtering policy and an intrusion detection policy and then informs the security management subsystem 200 of the attack.

Next, the security management subsystem 200 notifies the attack to the mobile terminal S1 of a manager by using short message service (SMS).

While the security network 20 having the security engine can block the intrusion, the general network 30 cannot block any intrusion, so that a general router S3-2 cannot perform a routing to a general system 10-2.

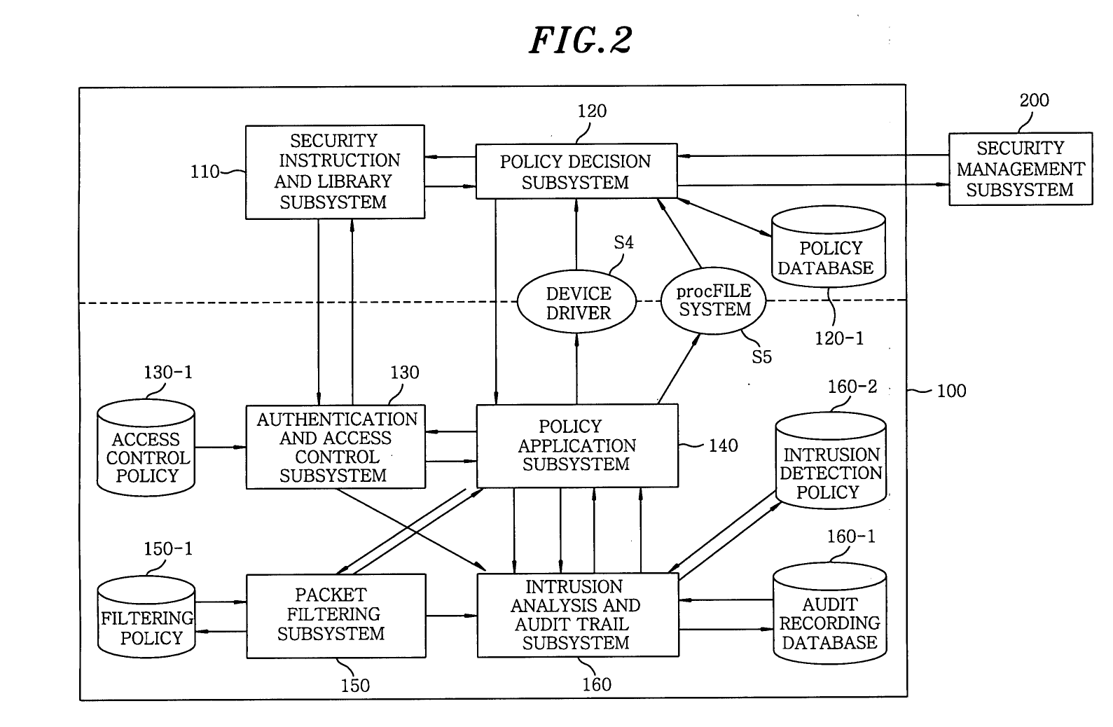

FIG. 2 illustrates a detailed diagram of the security network block 20 shown in FIG. 1. Each component thereof will be described in detail with reference to FIG. 2.

The router 100 having a security engine is composed of a security instruction and library subsystem 110, a policy determining subsystem 120 interworking with a policy database 120-1, an authentication and access control subsystem 130 interworking with an access control policy 130-1, a policy application subsystem 140, a packet filtering subsystem 150 interworking with a filtering policy 150-1, an intrusion analysis and audit trail subsystem 160 interworking with an intrusion detection policy 160-2 and an audit recording database 160-1.

The security instruction and library system 110, which requests an authentication and an access, and an access attribute acquisition/modification of the authentication and access control subsystem 130 and receives a result thereof, processes every application program and utility capable of accessing to a system source and provides an access attribute in response to the access attribute request of the policy determining subsystem 120.

The policy decision subsystem 120 determines a filtering policy, an intrusion detection policy and an access control policy that are required for detecting and blocking an intrusion and then provides the determined policies to the policy application subsystem 140. At the same time, the determined policies are stored in the policy database 120-1.

The authentication and access control subsystem 130 provides a result in respond to the authentication, the access, and the access attribute acquisition/modification that are requested by the security instruction and library subsystem 110. Furthermore, the authentication and access control subsystem 130 prevents an unauthorized user from using the system and allows an authorized user to access thereto in reference with the access control policy 130-1 in order to respond to the policy application subsystem 140, and then provides the result thereof to the policy application subsystem 140.

In other words, since only security manager has an authority to modify routing table information of a router, even if an unauthorized user discovers a password of a root by using a sniffing program and acquires a root authority, it is impossible to modify the routing table. As a result, the security of the router can be enhanced.

The policy application subsystem 140 analyzes the policies provided from the policy decision subsystem 120 and applies the polices to the authentication and access control subsystem 130, the packet filtering subsystem 150, and the intrusion analysis and audit trail subsystem 160.

Besides, the policy application subsystem 140 functions as an interface for providing intrusion detection and audit information from the intrusion analysis and audit trail subsystem 160 to the policy decision subsystem 120 through a device driver S4. Furthermore, the policy application subsystem 140 provides packet statistical information from the packet filtering subsystem 150 to the policy decision subsystem 120 through a proc file system S5.

The packet filtering subsystem 150 receives or denies a packet according to a policy application applied by the policy application subsystem 140 with reference to the filtering policy 150-1, and provides a result thereof to the policy application system 140. In this case, the filtering policy 150-1 is different depending on a sender address, a destination address, a sender port, a destination port, and a protocol type. In other words, the filtering policy 150-1 is used for blocking or passing a packet having a specific destination address or a packet using a protocol such as TCP, UDP, ICMP, and the like.

The intrusion analysis and audit trail subsystem 160 analyzes and copes with an intrusion of a network based on a policy application applied by the policy application subsystem 140 with reference to the intrusion detection policy 160-2 and then provides a result thereof to the policy application subsystem 140. In this case, the intrusion detection policy 160-2 includes rules for detecting a denial of service attack (DoS attack) and a specific virus pattern. Especially, in case a virus file is downloaded through a web browser, the intrusion analysis and audit trail subsystem 160 detects a virus file transfer by analyzing a pattern of the file and then notifies the virus file transfer to the security management subsystem 200 through the policy application subsystem 140, the device driver S4, and the policy determining subsystem 120. Then, the security management subsystem 200 informs a system manager of the virus file transfer through the web browser. Further, in case the attack system 10-1 attempts a DoS attack, the intrusion analysis and audit trail subsystem 160 blocks the DoS attack by examining a pattern thereof. Then, the detected patterns of the DoS attack or a virus attack are stored in the audit recording database 160-1.

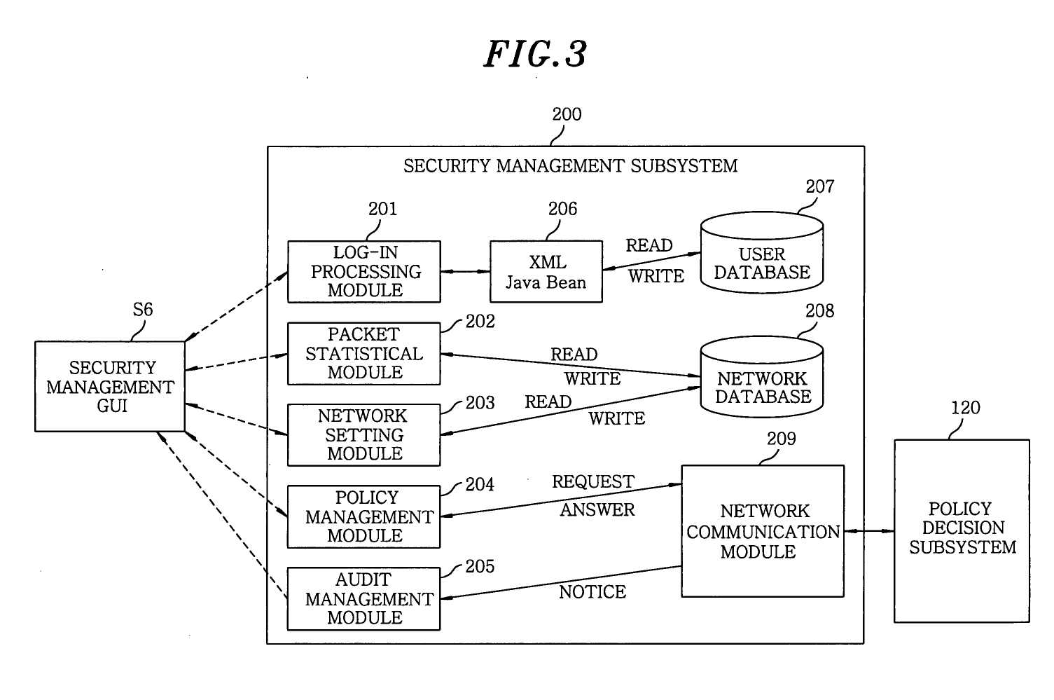

The security management subsystem 200 integratively manages the router 100 having a security engine. Specifically, entire network information are collected and stored in a network database 208 and the stored network information are retrieved to manage a network with help of a security management graphic user interface (GUI) S6 shown in FIG. 3. Further, an intrusion detection is notified to the system manager using a mobile terminal S1.

FIG. 3 provides a detailed diagram of the security management subsystem 200 shown in FIG. 2. Each component thereof will be described in detail with reference to FIG. 3.

The security management subsystem 200 includes a log-in processing module 201, a packet statistical module 202, a network setting module 203, a policy management module 204, an audit management module 205, an XML Java Bean 206, a user database 207, a network database 208, and a network communication module 209.

To be specific, a security management instruction is given to each of the modules 201 to 204 through the security management GUI S6 of a web base. In response to the instruction request from the security management. GUI S6, each of the modules 201 to 204 respectively performs a log-in process, processes a statistics of packets, displays a network status and provides management tools for an addition, a deletion, and a modification of policies to the security management GUI S6.

The audit trail module 205 receives audit information on an illegal intrusion from the policy decision subsystem 120 through the network communication module 209 and processes the audit information, to thereby provide the processed information to the security management GUI S6.

The security management GUI S6 communicates with the security management subsystem 200 by using a web browser. In case a user ID and a password are inputted through the web browser, the log-in processing module 201 responds to a log-in request by means of access to the user database 207 through the XML Java Bean 206 and reading/writing of the user database 207. In other words, the log-in processing module 201 allows or denies the log-in request, based on data in the user database 207.

The packet statistical module 202 shows packet statistic information on each of protocols and interfaces by using data stored in the network database 208. The network setting module 203 shows a network status of routers and systems through the security management GUI S6.

The network setting module 203 shows network interface information such as interface card type, an IP address, a hardware address, and a size, state and option of a maximum transmission unit (MTU), and system information such as OS information, a booting elapsed time, a current time, a system name, and a disc size. Further, the network setting module 203 is able to add, delete and edit a routing table.

The policy management module 204 shows a security policy for detecting a network intrusion and performs an addition, a deletion, and an edition thereof. In case an intrusion occurs during an off state, the intrusion is just detected. However, if an intrusion is detected during an on state, the intrusion is notified to a security manager by using an SMS. And the intrusion packet is automatically discarded due to an automatic removing function of the policy management module 204.

In case the router is exposed to a DoS attack or a virus attack, the audit management module 205 displays the attack information on the security management GUI S6 in real time and informs the security manager of the attack by using the SMS.

The network communication module 209 communicates with the policy decision subsystem 120 for a policy management and informs the audit management module 205 of the policy in real time.

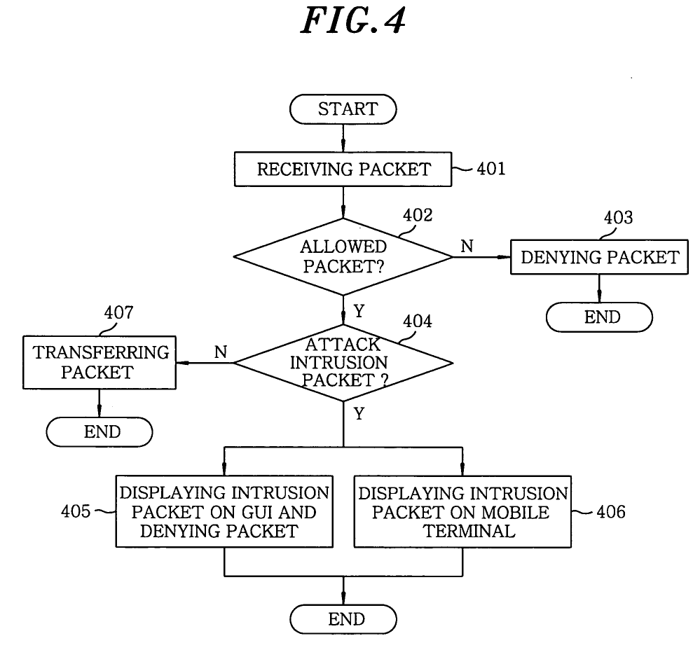

An operating process of the router having a security engine 100 in accordance with the present invention, which detects and copes in real time with an intrusion of the attack system 10-1, will be described in detail with reference to a flowchart of FIG. 4.

The router having a security engine 100 receives a packet from the attack system 10-1 through the hub S2-1 and the general router S3-1 and then examines the packet according to the filtering policy (step 401).

It is checked whether the packet is allowed or not, based on the examination result obtained by using the filtering policy (step 402).

If the packet is not allowed in the step 402, the packet is denied (step 403).

On the other hand, if the packet is allowed in the step 402, the packed is passed. Then, it is checked whether or not the packet is an attack intrusion packet by using the intrusion detection policy (step 404).

If the packet is found to be the attack intrusion packet in the step 404, the router having a security engine 100 displays the attack intrusion packet on the security management GUI S6 and denies the corresponding packet (step 405). Next, the router having a security engine 100 informs the attack intrusion packet on the mobile terminal S1 by using SMS (step 406).

On the other hand, if the packet is found to be a general packet in the step 404, the packet is transferred through a corresponding network (step 407).

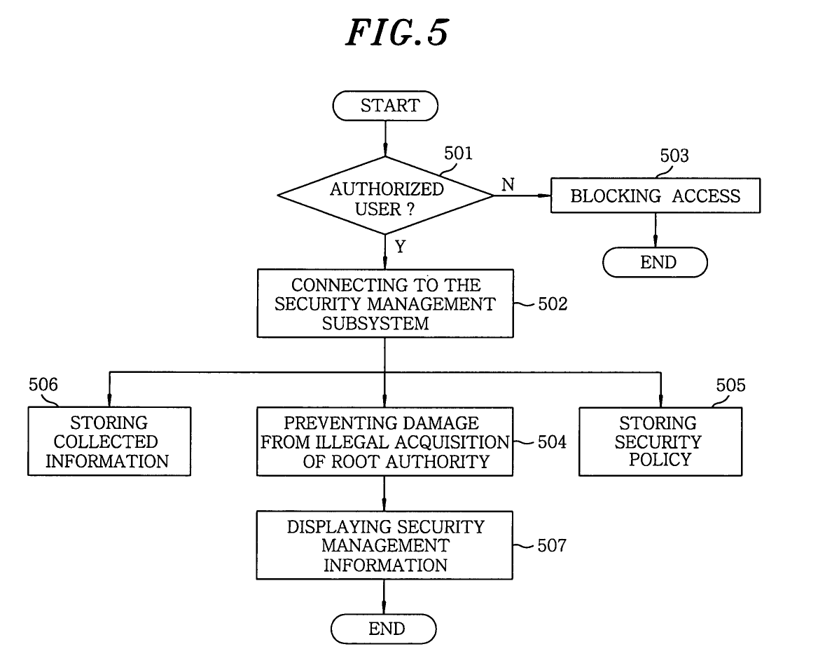

A process for providing an integrative security management by using a security policy applied between the router having a security engine 100 and the security management subsystem 200 in accordance with the present invention will be described in detail with reference to a flowchart of FIG. 5.

It is checked whether or not a user is authorized through a user registration and authentication process (step 501).

If the user is authorized in the step 501, the user can access to the security management subsystem 200 (step 502).

Unauthorized users are blocked to access to a significant source of network nodes, and damage generated by an illegal acquisition of a root authority is prevented (step 504).

The security policy, which is used for managing the security engine, is stored in the policy database 120-1 (step 505).

The security management subsystem 200 collects information on a network composition of hosts, gateways, and routers, and then stores the collected information in the network database 208 (step 506).

Thereafter, the security management subsystem 200 displays security management information on a web browser interworking with the security management GUI S6 (step 507).

If the user is not authorized in the step 501, the user is blocked to access to the security management subsystem 200 (step 503).

The security engine management apparatus and method in network nodes in accordance with the present invention, which have been described with reference to FIGS. 4 and 5, are implemented by corresponding programs. Such programs can be stored in a recording medium and executed in a hardware corresponding to the apparatus of the present invention or in a general hardware.

As described above, the present invention is able to optimize an intrusion detection and cope with an illegal network intrusion in real time by providing security functions of a packet filtering, an intrusion analysis and an audit trail, and an authentication and access control management in a kernel region for the security of network nodes such as a router, a gateway, or the like that have a security function against a network intrusion. Further, by managing the network nodes based on a security policy, it is possible to quickly cope with changes of a security environment. Moreover, the present invention is capable of solving security defects of conventional network nodes, providing an integrative security management, and improving the convenience and efficiency of the management by using a web browser.

While the invention has been shown and described with respect to the preferred embodiments, it will be understood by those skilled in the art that various changes and modifications may be made without departing from the spirit and scope of the invention as defined in the following claims.

1. A security engine management apparatus in network nodes comprising:
a security engine including:
a security instruction and library subsystem for processing every application program and utility that are allowed to access to a system source;
a policy decision subsystem for determining a filtering policy, an intrusion detection policy and an access control policy that are required for detecting and blocking an intrusion into a network;
an authentication and access control subsystem for preventing an unauthorized user from using a system and allowing an authorized user to access to the system in response to an application of the access control policy;
a policy application subsystem for analyzing and applying the policies;
a packet filtering subsystem for receiving an allowed packet and denying a disallowed packet in response to the application of the filtering policy; and
an intrusion analysis and audit trail subsystem for analyzing and coping with the intrusion into the network in response to the application of the intrusion detection policy, and
a security management subsystem for managing the security engine.

2. The security engine management apparatus in network nodes of claim 1, wherein the policy application subsystem provides intrusion detection and audit information through a device driver and packet statistical information through a proc file system to the policy decision system.

3. The security engine management apparatus in network nodes of claim 1, wherein the filtering policy is used for blocking or passing a packet having a certain destination address depending on a sender address, a destination address, a sender port, a destination port, and a protocol type.

4. The security engine management apparatus in network nodes of claim 1, wherein the intrusion detection policy includes rules for detecting a DoS attack and a specific virus pattern.

5. The security engine management apparatus in network nodes of claim 1, wherein in case the virus file is downloaded, the intrusion analysis and audit trail subsystem detects the virus file transfer by examining a file pattern and then informs the virus file transfer on a mobile terminal; and in case the DoS attack is attempted, the intrusion analysis and audit trail subsystem examines a DoS attack pattern to block the DoS attack, thereby storing detection information on the DoS attack and the virus attack in an audit recording database.

6. The security engine management apparatus in network nodes of claim 1, wherein the security management subsystem further includes:
a security management GUI of a web base, for executing a management instruction;
an audit management module for processing audit information on an illegal intrusion;
a log-in processing module for performing a user authentication by using a user ID and a password inputted from the mobile terminal;
a packet statistical module for showing packet statistical information on each of protocols and an interfaces;
a network setting module for showing a network status for routers and systems through the security management GUI;
a policy management module for displaying a security policy for detecting a network intrusion and performing an addition, a deletion, and an edition thereof;
an audit management module for displaying information on the DoS attack and the virus attack on the mobile terminal by using a short message service (SMS); and
a network communication module for communicating with the policy decision subsystem for a policy management and informing the audit management module of the policies in real time.

7. The security engine management apparatus in network nodes of claim 6, wherein the network setting module displays network interface information on an interface card type, an IP address, a hardware address, and a size, state and option of maximum transmission unit (MTU), and system information on OS information, a booting elapsed time, a current time, a system name, and a disc size, and performs an addition, a deletion, and an edition of a routing table.

8. The security engine management apparatus in network nodes of claim 6, wherein in case an intrusion occurs during an off state, the policy management module only detects the intrusion; and in case the intrusion is detected during an on state, the policy management module informs the mobile terminal of the intrusion by using an SMS and then discards the intrusion packet.

9. A method for security engine management in network nodes, comprising the steps of:
(a) receiving a packet from an attack system and examining the packet according to a filtering policy;
(b) checking whether the packet is allowed or not, based on the examination result of step (a);
(c) passing the packet if the packet is allowed in the step (b) and checking whether or not the allowed packet is an attack intrusion packet according to an intrusion detection policy; and
(d) in case the packet is the attack intrusion packet in the step (c), displaying the attack intrusion packet on a security management GUI and informing a mobile terminal by using an SMS and denying the corresponding packet.

10. The security engine management method in network nodes of claim 9, wherein if the packet is disallowed in the step (b), the disallowed packet is denied.

11. The security engine management method in network nodes of claim 9, wherein if the packet is a general packet in the step (c), the packet is transferred through a network.

12. A method for providing an integrative security management by using a security policy applied between a router and a security management subsystem, the method comprising the steps of:
(a) checking whether or not a user is authorized through a user registration and authentication process;
(b) if the user is authorized in step (a), allowing a user to access to the security management subsystem, collecting information on a network composition of hosts, gateways, and routers and storing the collected information in a network database; and
(c) displaying security management information on a security management GUI.

13. The method of claim 12, wherein if the user is not authorized in the step (a), the user is blocked to access to the security management subsystem and system sources of network nodes to prevent damage generated by an illegal acquisition of a root authority.

14. The method of claim 13, wherein if the user is not authorized in the step (a), a security engine is managed based on a security policy and the security policy is stored in a policy database.

15. A recording medium for recording therein a program for implementing a method of claim 9.

16. A recording medium for recording therein a program for implementing a method of claim 12.
